(19) United States
(12) Patent Application Publication
(10) Pub. No.: US 2005/0172429 A1
(43) Pub. Date: Aug. 11, 2005

(54) Toothbrush for creating a whitening effect

(75) Inventors: Bruce M. Russell, Howell, NJ (US); Robert A. Moskovich, East Brunswick, NJ (US); Diego Hoic, Jersey City, NJ (US)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 10/776,972

(22) Filed: Feb. 11, 2004

(51) Int. Cl. A46B 9/04; A61C 17/00

(52) U.S. Cl. 15/22.1; 15/105; 15/167.1; 433/29

(57) ABSTRACT

A toothpaste formulation contains ultraviolet brighteners as a whitening ingredient. Such optical brighteners have a whitening or bleaching effect when in contact with ultraviolet radiation. The activation of the brighteners preferably occurs through the use of a toothbrush having a UV source which transmits light through the bristle field of the toothbrush. The toothbrush could be a manual toothbrush or a powered toothbrush.

### BACKGROUND OF THE INVENTION

Various techniques have been used for creating a whitening effect of a user's teeth. Current at home tooth whitening techniques require several days for the user to see the effect of the treatment and are generally considered to be inconvenient and in some cases difficult to use. It would be desirable to provide techniques which give a more immediate whitening effect so as to encourage the user to have a regular brushing program in addition to giving the satisfaction of whiter teeth.

### SUMMARY OF THE INVENTION

An object of this invention is to provide techniques for giving a more immediate whitening effect on a user's teeth.

A further object of this invention is to provide such techniques which utilize a toothbrush in connection with creating the whitening effect.

In accordance with this invention optical brighteners are incorporated in a carrier, such as toothpaste. The brighteners have the characteristic of being able to have a whitening or bleaching effect when coming into contact with ultraviolet radiation. The carrier would also include an adhering agent which would adhere to the teeth while the brighteners adhere to the adhering agent. As a result the brighteners remain on the outer surface of the teeth. In the broad practice of this invention an ultraviolet light source is used for directing ultraviolet light against the teeth so that the whitening effect would be created and easily visible to the user.

In a preferred practice of this invention the ultraviolet light source is incorporated in a toothbrush. The carrier for the brightener is preferably the toothpaste on the toothbrush cleaning head.

### THE DRAWINGS

FIG. 1 is a side elevational view of a manual toothbrush in accordance with this invention;

FIG. 2 is a front elevational view of the toothbrush shown in FIG. 1;

FIG. 2A is a view similar to FIG. 2 showing a toothbrush head with surface mounted LED's;

FIG. 3 is a side elevational view of a powered toothbrush in accordance with this invention; and

FIG. 4 is a front elevational view of the toothbrush shown in FIG. 3.

### DETAILED DESCRIPTION

The present invention broadly involves applying an optical brightener to a user's teeth. The brightener has the characteristic that it can be actuated by the presence of ultraviolet radiation, such as that present in sunlight, and would then have a whitening or bleaching effect that would be easily visible to the user. In a preferred practice of this invention the ultraviolet radiation is emitted from a toothbrush; such that as a result, when the user is brushing the user's teeth there is an immediate, significant, visual whitening appearance. In a broad practice of this invention, however, the ultraviolet or UV light source could be any device that provides the light emissions for observing the teeth.

Various types of carriers may be used for applying the brightener to the teeth. The preferred form of carrier is incorporating the brightener in the toothpaste itself. As later described any suitable form of carrier may be used. The carrier would also include an adhering agent which would adhere to the teeth while the brighteners adhere to the adhering agent. As a result the brighteners remain on the outer surface of the teeth. A preferred adhering agent is a gantrez polymer, such as is used in antibacterial toothpastes to retain the antibacterial agent on the tooth surfaces. In the practice of this invention the optical brighteners could be selected from such types of brighteners which adhere to the whitening ingredients in such toothpastes and thereby the optical brighteners also remain on the teeth. Other forms of carriers could be conventional products that would be applied to the mouth. Such products include, but are not limited to, an oral rinse or mouthwash, a gum or lozenge, a polymer strip or any other common means of delivering oral health benefits. These carriers would also include some form of adhering agent which would deposit the brighteners on the surface of the teeth.

The presence of the optical brighteners on the teeth give a white appearance when in the appearance of ultraviolet or fluorescent light. Such white appearance results when ultraviolet light or radiation is directed to the teeth such as by being incorporated in a toothbrush. The white appearance results from a combination of the bluish light from the radiation combining with any yellowness on the teeth to give a more white appearance. This same appearance would occur when the optical brighteners are in the presence of fluorescent lights in a room or in sunlight. The immediate creation of the whitening appearance would be beneficial in encouraging a user to have a regular brushing program so as to continue obtaining the whitening effect.

The benefit of incorporating the optical brighteners in toothpaste is that the optical brighteners would be applied through the brushing of one's teeth which would be reasonably easy and familiar to all users. If the optical brightener is incorporated in other forms of carriers the carriers should be such that the optical brighteners sufficiently adhere to the teeth to be present on the teeth and have the brightening effect when in the presence of ultraviolet energy. The activation of the brightener could thus occur through use of a special toothbrush as later described in which UV light is allowed to be transmitted through the bristle field of the toothbrush.

Any suitable optical brightener could be used in the practice of this invention. Suitable optical brighteners are common in the pulp and paper industry as well as being use in applications such as laundry detergent. Other uses of suitable optical brighteners are found in commercially available materials used to trace leaks in water systems. When these materials come into contact with ultraviolet radiation they have a whitening or bleaching effect. Typically, this chemical reaction occurs relatively quickly after the activation of the ultraviolet energy. One form of suitable brightener is TINOPAL, marketed by Ciba Geigy. Preferably only a small amount of brightener is necessary, such as 0.075 to 0.30% by volume of the total combination of the carrier and brightener.

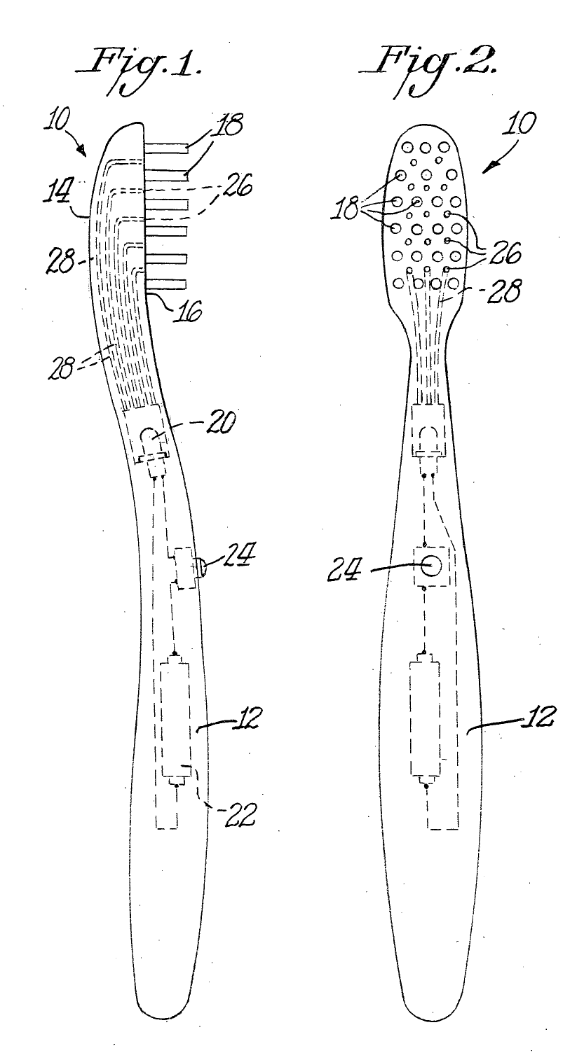

FIGS. 1-2 show a manual toothbrush 10 that may be used in accordance with this invention. As shown therein the toothbrush 10 includes a hollow handle 12 and a cleaning head 14. Cleaning head 14 has an outer surface 16 from which a plurality of cleaning elements 18 extend outwardly. Cleaning elements 18 may be of any suitable form such as bristles or elastomer members of any size or shape. The cleaning elements may also be a combination of different types of cleaning elements. The cleaning elements 18 are arranged on the outer surface 16 of the cleaning head to form a cleaning field.

Mounted within the hollow handle 12 is a source 20 of ultraviolet light. Any suitable source may be used such as miniature UV bulbs as manufactured by Welch Allyn.

Although miniature UV bulbs may be used this is a less preferred practice of the invention in that generally such bulbs are of relatively large size with high power consumption and tend to emit undesired UVB radiation. A more preferred practice of the invention would be the use of LEDs as the source 20 of ultraviolet light. A particular advantage of LEDs is that they can be surface mounted. In addition LEDs would have small or low power consumption and provide tight emissions in a tight spectrum band with minimum power requirements and have relatively low intensity. The LEDs could preferably have a safe UVA wavelength of 350-410 nm and more preferably a wavelength of 378-383 nm. Suitable LEDs can be obtained from Roithner Lasertechnik of Vienna, Austria. A suitable LED would be a 3.0×2.2×1.5 nm 3TOP LED. Whatever form of source is used, care should be taken to control the intensity of the UV radiation in order to avoid possible negative health effects.

Although the ultraviolet light can constantly be emitted, it is preferable that the light source be selectively actuated. Any suitable structure could be used for accomplishing that task. FIGS. 1-2, for example, show the hollow handle 12 to include a battery 22 electrically connected to the UV light source 20. A switch 24 located externally on the handle 12 selectively actuates the light source 20.

When the light source 20 is actuated the light is transmitted from the handle to the carrier field and to at least one emitter 26 in the carrier field. The light could be transmitted in any suitable manner by transmitting structure 28 such as a light pipe, fiber optic, or other suitable devices. Preferably, the light(s) or emitters 26 are surface mounted and are located in the carrier field. FIG. 2A shows two surface mounted emitters 26 in the form of LEDs.

In one use of toothbrush 10 toothpaste would be applied to the outer ends of the cleaning elements 18, such as bristles. The toothpaste would incorporate the optical brighteners. In the normal use of the toothbrush the toothpaste would be applied to the teeth. The brighteners in the toothpaste would become attached to the tooth surface. Either during or immediately after the brushing the user would actuate the ultraviolet light source 20 through switch 24 to radiate the ultraviolet light from the emitters toward the teeth. The brighteners in the presence of the ultraviolet radiation, would create a whitening effect.

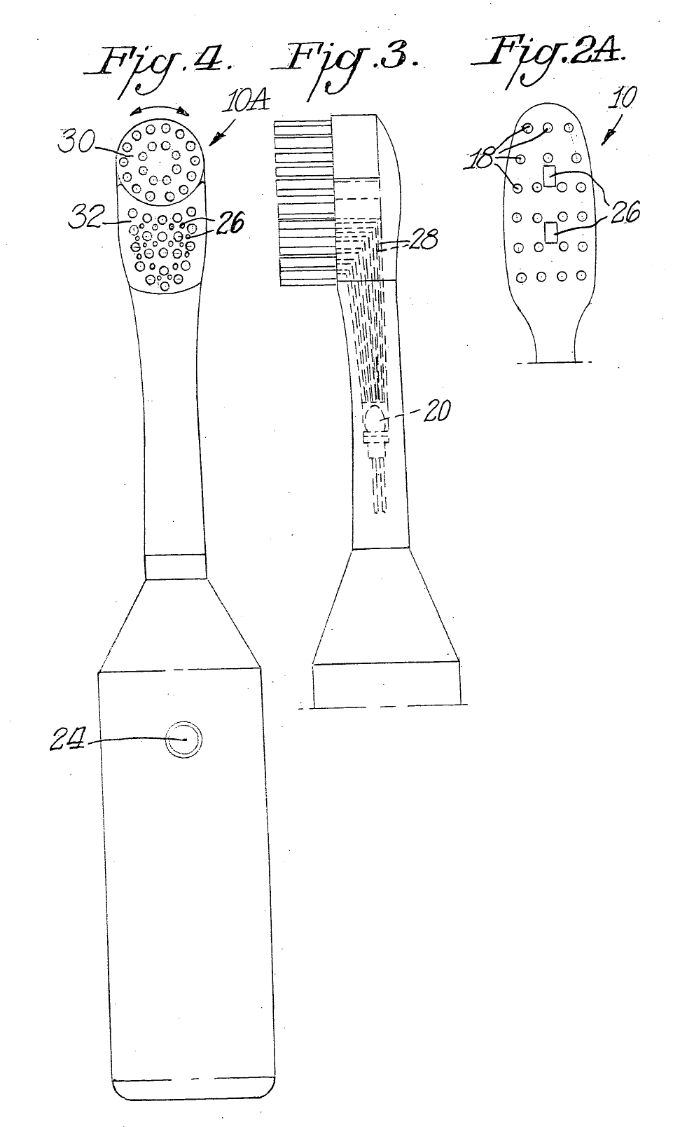

Although FIGS. 1-2 illustrate the toothbrush to be a manual toothbrush it is also possible to practice the invention with a powered toothbrush 10A as shown in FIGS. 3-4. In that embodiment the powered toothbrush includes a moveable section 30 in the cleaning field. Movable section 30 could be of any size or shape and could be moved in any known manner such as continuous rotation in one direction, oscillating rotation or linear back and forth and/or side to side movement. One example of movement is an oscillating back and forth rotational movement such as disclosed in U.S. Pat. No. 5,625,916, all of the details of which are incorporated herein by reference thereto. In the illustrated embodiment toothbrush 10A includes in its cleaning field a fixed portion 32 which does not move but which also contains cleaning elements. For the sake of simplicity the emitters are located only in the fixed portion 32 rather than having to account for the movability of the optic fibers or light pipe if the emitters were also located in the movable section 30. It is, however, in the scope of this invention that the emitters could be in either the movable section 30 and/or the fixed section 32.

The invention could be practiced where the same switch 24 actuates both the light source 20 and the drive mechanism for the movable section 30. Alternatively, the movable section and the light source could be actuated by separate switches.

1. A toothbrush for creating a whitening effect on a user's teeth, comprising a handle, a cleaning head attached to said handle, said cleaning head having an outer surface, cleaning elements on said cleaning head extending outwardly from said outer surface, said cleaning elements being located in a cleaning field, said toothbrush having an ultraviolet light, and said ultraviolet light having an emitter in said cleaning field to radiate ultraviolet light toward the user's teeth for activating an optical brightener on the user's teeth to create a visual whitening effect.

2. The toothbrush of claim 1 wherein said handle is hollow, said ultraviolet light having a light source in said handle, and light transmission structure transmitting the ultraviolet light to said emitter.

3. The toothbrush of claim 2 wherein said light source is a miniature UV bulb.

4. The toothbrush of claim 2 wherein said light source is UV emitting LED's.

5. The toothbrush of claim 4 wherein said at least one LED is surface mounted to said toothbrush.

6. The toothbrush of claim 5 wherein said at least one LED has a wavelength of 350-410 nm.

7. The toothbrush of claim 2 wherein said toothbrush is a manual toothbrush.

8. The toothbrush of claim 7 wherein said light source is selectively actuated by a switch on said handle.

9. The toothbrush of claim 2 wherein said toothbrush is a powered toothbrush having a movable cleaning element carrying section in said cleaning head.

10. The toothbrush of claim 9 wherein said light source is selectively actuated by a switch on said handle.

11. The toothbrush of claim 10 wherein said switch also actuates said movable section.

12. The toothbrush of claim 9 wherein said cleaning head also includes a non-movable fixed section having cleaning elements, and said emitter is located in said fixed section.

13. The toothbrush of claim 1 wherein said emitter emits UV light from plural locations in said cleaning field.

14. The toothbrush of claim 1 wherein at least some of said cleaning elements are bristles.

15. A method for creating a whitening effect on a user's teeth comprising incorporating in a carrier an optical brightener which is capable of attaching to the teeth and which has the characteristic of having a whitening effect in the presence of UV light, applying the carrier to the user's teeth, attaching the brightener to the user's teeth, radiating UV light from a UV light source toward the user's teeth, and creating a whitening effect by the UV light activating the brightener.

16. The method of claim 15 wherein the UV light source is in a toothbrush.

17. The method of claim 16 wherein the carrier is toothpaste applied to the toothbrush.

18. The method of claim 17 wherein the toothpaste includes an adhering agent which adheres to the teeth and the brightener adheres to the adhering agent.

19. The method of claim 17, wherein the adhering agent is gantrez.

20. The method of claim 16 wherein the UV light source is selectively activated by a switch.

21. The method of claim 16 wherein the toothbrush is a manual toothbrush.

22. The method of claim 16 wherein the toothbrush is a powered toothbrush.
